(19) United States
(12) Patent Application Publication
(10) Pub. No.: US 2004/0248476 A1
(43) Pub. Date: Dec. 9, 2004

(54) Banana plug

(76) Inventor: Hongbin Zhang, Shanghai (CN)

Correspondence Address: DORSEY & WHITNEY LLP, Intellectual Property Department, Suite 1500, 50 South Sixth Street, Minneapolis, MN, 55402-1498, US

(21) Appl. No.: 10/887,133

(22) Filed: Jul. 8, 2004

Related U.S. Application Data
(63) Continuation of application No. PCT/CN03/00448, filed on Jun. 9, 2003.

(30) Foreign Application Priority Data
Jun. 26, 2002 (CN) 02 2 65047.4

(51) Int. Cl. H01R 13/05

(52) U.S. Cl. 439/825

(57) ABSTRACT

A banana plug comprising a core pole and copper outer tube, elastic outer copper hull which wrap subsection out of the core pole, wherein a mandril aperture is extending through the core pole in its longitudinal direction, an insulative sheath is attached to inner wall of the mandril aperture, and an inner-contact hollow copper pole with a deep hole or a through hole at tip, is inserted into the insulative sheath. The banana plug is configurated to the inner copper pole, outer tube which are insulative each other by means of improving structure inside of the core pole without changing outer shape and structure of the plug. It provides two contacts or an additional optical contact.

### CROSS-REFERENCE TO RELATED APPLICATION(S)

This application is a continuation of International Application No. PCT/CN03/00448, filed on Jun. 9, 2003, which claims priority to Chinese Application No. CN 02 2 65047.4, filed on Jun. 26, 2002, the contents of both applications are incorporated in their entirety by reference.

### FIELD OF THE INVENTION

This invention is related to a banana plug, and particularly, to a banana plug for measure line of an apparatus or a meter.

### BACKGROUND OF THE INVENTION

An existing banana plug is composed of a core pole which is solid, and copper outer tube, elastic outer copper hull which wrap subsection out of the core pole. Since the banana plug in such a structure can connect only one electrical contact, for example, a positive electrode, a negative electrode or other signal, it is apparent that the banana plug is not able to fulfill such user requirements as a particular requirement that a user need a banana plug to be capable of linking two contacts, for example, linking both an electric appliance contact and an optical fiber contact, or two electric appliance contacts etc. to add device functions.

### BRIEF SUMMARY OF THE INVENTION

The present invention is directed to provide a banana plug, which can connect simultaneously two or more than two contacts for fulfilling various user requirements.

A banana plug provided by the present invention, comprises a core pole and copper outer tube, elastic outer copper hull which wrap subsection out of the core pole, wherein, a mandril aperture is extending through the core pole in its longitudinal direction, an insulative sheath is attached to inner wall of the mandril aperture, and an inner-contact hollow copper pole with a deep hole or a through hole at tip is inserted into the insulative sheath.

Since the technical solution described above is employed to fulfill various user requirements, that is, the banana plug is configurated to the inner copper pole, outer tube which are insulative each other by means of improving structure inside of the core pole without changing outer shape and structure of the plug, thus it provides two contacts or an additional optical contact.

### BRIEF DESCRIPTION OF THE DRAWINGS

FIG. 1 illustrates a schematic diagram of outer shape structure of a banana plug in prior art or a banana plug of the present invention;

FIG. 2 is a structural sectional view of a banana plug of the present invention.

### DETAILED DESCRIPTION OF THE INVENTION

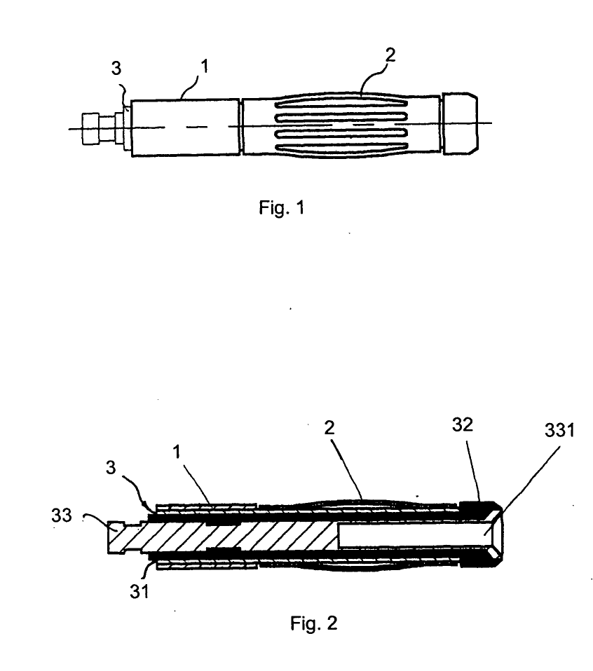

As shown in FIG. 1 and FIG. 2, a banana plug of the present invention, is composed of copper outer tube 1, elastic outer copper hull 2 and a core pole 3, a mandril aperture 31 is extending through the core pole 3 in its longitudinal direction, an insulative sheath 32 is attached to inner wall of the mandril aperture 31, and an inner-contact hollow copper pole 33 with a deep hole 331 at tip, is inserted into the insulative sheath 32. The deep hole 331 can also be a through hole.

Copper outer tube 1 and elastic outer copper hull 2 act as an electrical appliance contact to link a device, the inner-contact hollow copper pole 33 acts as another contact to link a device. If an optical fiber goes through the inner-contact hollow copper pole 33, it can also link an optical signal.

1. A banana plug comprising a core pole and copper outer tube, elastic outer copper hull which wrap subsection out of the core pole, wherein a mandril aperture is extending through the core pole in its longitudinal direction, an insulative sheath is attached to inner wall of the mandril aperture, and an inner-contact hollow copper pole with a deep hole or a through hole at tip is inserted into the insulative sheath.
